(19) United States
(12) Patent Application Publication
(10) Pub. No.: US 2007/0078847 A1
(43) Pub. Date: Apr. 5, 2007

(54) SYSTEM AND METHOD FOR GENERATING A PLAY-LIST

(76) Inventors: Kuan-Hong Hsieh, Shenzhen (CN); Zai-An Pan, Shenzhen (CN); Xiao-Guang Li, Shenzhen (CN); Bing Li, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,154

(22) Filed: Jun. 29, 2006

Related U.S. Application Data
(63) Continuation-in-part of application No. 11/308,697, filed on Apr. 24, 2006.
(63) Continuation-in-part of application No. 11/308,707, filed on Apr. 24, 2006.
(63) Continuation-in-part of application No. 11/308,708, filed on Apr. 24, 2006.
(63) Continuation-in-part of application No. 11/308,751, filed on Apr. 28, 2006.

(30) Foreign Application Priority Data
Jul. 8, 2005 (CN) 200510035918.0
Jun. 17, 2005 (CN) 200510035413.4
Jun. 24, 2005 (CN) 200510035542.3
Jun. 24, 2005 (CN) 200510035531.5
Jun. 24, 2005 (CN) 200510035533.4

(51) Int. Cl. G06F 17/30

(52) U.S. Cl. 707/5

(57) ABSTRACT

A system for generating a play-list includes a media player and a media file server. The media player automatically generates weight values of each media file therein. The media file server stores a plurality of category tables, each category table storing a desired sub-category and corresponding sub-category weight values; initializes the category tables in response to an operational input for generating a play-list; obtains a predetermined amount of media files from the media player; reads the desired sub-categories and the weight values of the obtained media files; increments a corresponding sub-category weight value in the corresponding initialized category tables by the read weight values; calculates final weight values of each media file according to the category tables; and generates the play-list of the media files according to the final weight values thereof. The present invention also provides a corresponding method that makes the play-list more suitable for the user's favors.

### CROSS-REFERENCES TO RELATED APPLICATION

This application is a continuation-in-part application of U.S. patent application Ser. No. 11/308,697 entitled “system and method for generating a play-list,” filed on Apr. 24, 2006, U.S. patent application Ser. No. 11/308,708 entitled “system and method for generating a play-list,” filed on Apr. 24, 2006, U.S. patent application Ser. No. 11/308,707 entitled “system and method for generating a play-list,” filed on Apr. 24, 2006 and U.S. patent application Ser. No. 11/308,751 entitled “system and method for generating a play-list,” filed on Apr. 28, 2006, having the same assignee.

### TECHNICAL FIELD

The present invention relates to a system and method for generating a media play-list automatically, especially to a system and method for automatically generating a play-list according to adjusted weight values of the media files.

### DESCRIPTION OF RELATED ART

The continuous development of new digital technology has helped made digital devices such as digital audio, digital picture, and other digital medias become popular among people. Media can be stored digitally in various data storage medium such as a hard disk, a compact disc (CD), and a network server. These data storage medium can then be used with portable devices such as a personal digital assistant (PDA), a media player, and/or an electronic-book reader (e-book). A current standard CD can store up to 140 average sized MPEG layer three (MP3) media files, whereas a media player with a data storage medium of 10 Gigabytes can store up to 2000 MP3 files. The cost of data storage medium has continued to decrease, allowing the average person to more easily acquire more data storage capacity. Currently, a personal computer has a standard data storage capacity of 80 Gigabytes that can easily store up to 160,000 pieces of average sized MP3 files. As users continuously acquire their favorite media files, it is important that users can also quickly identify and select a desired media file from a humongous pool of stored files.

Most media players currently have an option to group and select media files by the media file's tag contents. Usually, the media file's title, artist, album, and genre identity are stored by the tags to allow media players to automatically search and categorize the files. A media file management program further allows users to select a combination of media files into a play-list file. The saved play-list is essentially a list of shortcuts (pointer to the directory path) of the media files stored within, and can be used by the media player instead of manually searching and selecting every desired media files each time the media player is executed. Each play-list can then be categorically stored by name. However, users are still required to remember the directory path where each play-list is stored. As a user creates more and more play-lists, remembering a desired play-list may not be easy, furthermore, skipping over an unwanted media file while playing a play-list still has to be done manually.

In order to solve the problems mentioned, there is a method available in the market in selecting favorite media files to generate a play-list. For example, U.S. Pat. No. 6,987,221 issued on Jan. 17, 2006 and entitled “AUTO PLAYLIST GENERATION WITH MULTIPLE SEED SONGS” provides a method for generating a play-list automatically. The method includes steps of: selecting one or more feed media files, the feed media files include desired media files and undesired media files; wherein the user can set a weight on each seed media file representing the importance level of each seed media file. Afterwards, the method compares each media file with each seed media file such that a media file can be analyzed and identified into a user defined preferred play-list. The play-list further allows manual edits by the user.

However, the above mentioned method requires manual inputs on the weight attributes on multiple seed files before the method can run comparison tests on each media files. These manual operations may be annoying and time consuming with no guarantee that the resulting selected media files would be tailored to a user's listening preferences.

Therefore, a heretofore unaddressed need exists in the industry to overcome the aforementioned deficiencies and inadequacies.

### SUMMARY

After a media player generates weight values of each media file according to a listener's preference during the course of the media files being listened, the listener also wishes to select a plurality of preferable media files from a media file library according to the listened media files with weight values being larger than a predetermined value. In order to solve said problems, the present invention provides a method and system for generating final weight values of the media files according to the weight values and the desired sub-categories thereof, whereby generating a new play-list automatically. The present invention makes the play-list more suitable to the listener's listening preferences.

The method for generating a play-list of media files in a media file server according to analyzing a plurality of media files in a media player, each of the media files comprising a tag for holding a plurality of fields thereupon. The method includes the steps of: setting a weight field and a plurality of category fields in the tag, the weight field storing a weight value of the media file, and each category field storing a plurality of desired sub-categories corresponding to the media file; setting a plurality of category tables in the media file server, each category table storing a desired sub-category and corresponding sub-category weight values; resetting sub-category weight values associated with the desired sub-category in the category tables to zero in response to a control command for generating a play-list; sending an access signal to a media player; receiving the access signal from the media file server; rearranging the media files stored in the media player based on the weight values in the weight fields of each media file in descending order in response to the access signal; obtaining a predetermined amount of media files on the top of the ordered list from the media player; reading desired sub-categories and weight values in the category fields of the obtained media files; incrementing a corresponding sub-category weight value in the corresponding initialized category tables by the weight values of the obtained media files; calculating final weight values of each media file according to the category tables; and generating the play-list of the media files according to the final weight values thereof.

The system for generating a play-list includes a media player and a media file server each of them storing a plurality of media files. Each of the media files includes a tag for holding a plurality of fields. The tag of each media file includes a weight field and a plurality of category fields, the weight field storing a weight value thereof, each category field storing a plurality of desired sub-categories corresponding to the media file. The media file server includes a data storage unit and a play-list management unit. The data storage unit stores a plurality of category tables, each category table storing a desired sub-category and corresponding sub-category weight values. The play-list management unit resets sub-category weight values associated with the desired sub-category in the category tables to zero in response to a control command for generating a play-list, and sends an access signal to the media player. The media player includes a file management unit. The file management unit rearranges the media files stored in the media player based on the weight values in the weight fields of each media file in descending order in response to the access signal. In addition, the play-list management unit obtains a predetermined amount of media files on the top of the ordered list from the media player; reads desired sub-categories and weight values in the category fields of the obtained media files; increments a corresponding sub-category weight value in the corresponding initialized category tables by the weight values of the obtained media files; calculates final weight values of each media file according to the category tables; and generates the play-list of the media files according to the final weight values thereof.

Other systems, methods, features, and advantages will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF DRAWINGS

FIG. 1 is a block diagram of a hardware infrastructure of a system for generating a play-list in accordance with a preferred embodiment of the present invention;

FIG. 2 is a schematic diagram of main function modules of a file management unit of a media player in FIG. 1;

FIG. 3 is a schematic diagram of main function modules of a play-list management unit of a media player in FIG. 1;

FIG. 4 is a flowchart of a preferred method for generating a play-list in a media file server in FIG. 1;

FIG. 5 is a flowchart of a preferred method for calculating sub-category weight values of desired sub-categories in FIG. 4;

FIG. 6 is a flowchart of a preferred method for calculating final weight values of each media file in FIG. 4;

FIG. 7 is a schematic diagram representing a relationship between an artist and a sub-category weight value in a first category table; and

FIG. 8 is a schematic diagram representing a relationship between a genre and a sub-category weight value in a second category table.

### DETAILED DESCRIPTION OF A PREFERRED EMBODIMENT

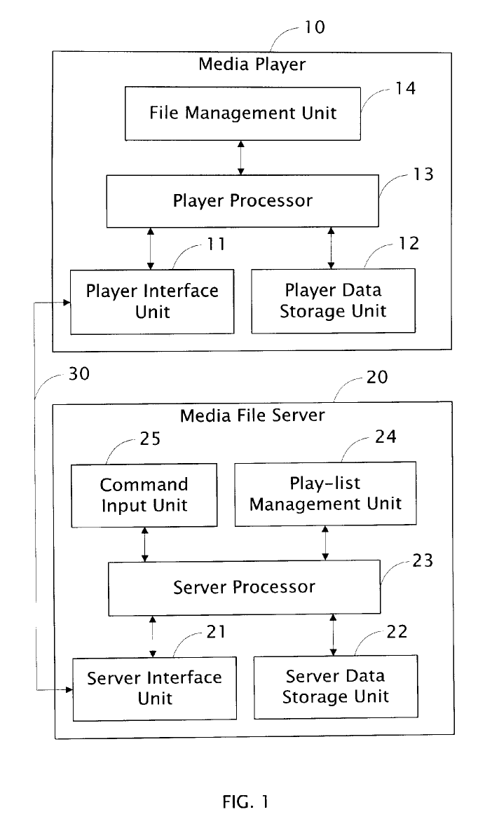

FIG. 1 is a block diagram of a hardware infrastructure of a system for generating a play-list in accordance with a preferred embodiment of the present invention. The system for generating a play-list includes a media player 10 and a media file server 20. The media player 10 can be remotely connected to the media file server 20 via a network, or locally connected to the media file server 20 via data lines. In addition, the media player 10 can be a computer or a portable device (e.g., an MP3 player or an MP4 player) with media playing software (e.g., Realplayer or iTunes). In the preferred embodiment, for simplicity, the connection between the media player 10 and the media file server 20 adopts the data lines connection as an example, concurrently, the media player 10 takes an MP3 player for description below. Corresponding to the data lines connection, the media player 10 and the media file server 20 respectively provide a player interface unit 11 and a server interface unit 21 for connecting the data lines 30 therebetween. The player interface unit 11 and the server interface unit 21 can be a wireless transmittal interface (such as, Bluetooth or Winmax), or a wired transmittal interface (such as, a network transmittal interface or a USB). Preferably, the interface units are USB interfaces.

The media player 10 includes a player data storage unit 12, a player processor 13, and a file management unit 14. The media file server 20 includes a server data storage unit 22, a server processor 23, a play-list management unit 24, and a command input unit 25. The player data storage unit 12 and the server data storage unit 22 stores a plurality of media files respectively. Each of the media files includes a tag for holding a plurality of fields about the media file. The tag includes a weight field, an artist field, a genre field, etc., to store corresponding sub-categories such as a sub-category weight value, an artist, a genre, and so on. The sub-category weight value would indicate the user's preference level on a given media file.

The player data storage unit 12 further includes a play-list. The server data storage unit 22 further includes one or more category tables. With respect to the category tables, for simplicity, in the preferred embodiment, two category tables (i.e., a first category table and a second category table) are adopted as examples and described in detail below. Each category table is used for recording a desired sub-category and its corresponding sub-category weight values. For example, the first category table records the artists and their corresponding sub-category weight values, and the second category table records the genres and their corresponding sub-category weight values. In addition, the server data storage unit 22 can be a flash storage, a hard disk driver, and the like.

The command input unit 25 generates commands in response to operational inputs. The server processor 23 receives and identifies the commands from the command input unit 25, and generates corresponding control commands to control the server data storage unit 22, the play-list management unit 24, and the like. The control commands include a control command for generating a play-list (namely a play-list generation control command).

The file management unit 14 automatically generates weight values of each media file listed on the play-list stored in the player data storage unit 12 as described in U.S. patent application Ser. No. 11/308,697 entitled “system and method for generating a play-list,” filed on Apr. 24, 2006, U.S. patent application Ser. No. 11/308,708 entitled “system and method for generating a play-list,” filed on Apr. 24, 2006, U.S. patent application Ser. No. 11/308,707 entitled “system and method for generating a play-list,” filed on Apr. 24, 2006, herein incorporated in its entirety by referenced and U.S. patent application Ser. No. 11/308,751 entitled “system and method for generating a play-list,” filed on Apr. 28, 2006.

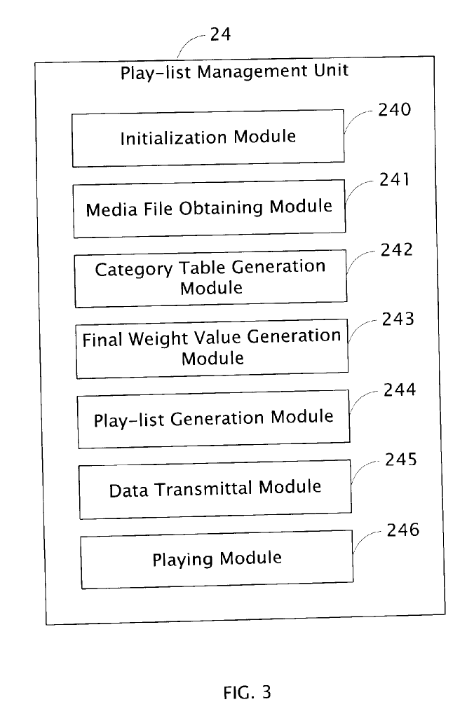

Referring to FIG. 3, the play-list management unit 24 includes an initialization module 240 and a media file obtaining module 241. In response to the play-list generation control command, the initialization module 240 resets sub-category weight values associated with the sub-categories in the category tables to zero (namely initializing the category tables). After the initialization, the media file obtaining module 241 sends an access signal to the file management unit 14 of the media player 10 through the connection between the player interface unit 11 and the server interface unit 21.

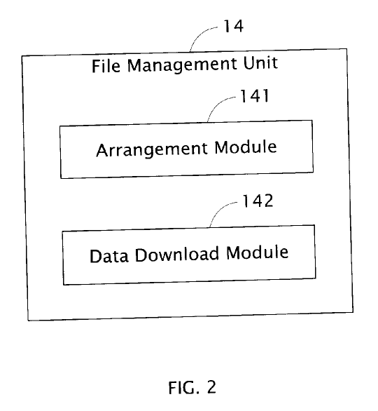

Referring to FIG. 2, in response to the access signal, the file management unit 14 further provides an arrangement module 141 to arrange the media files stored in the player data storage unit 12 in descending order based on the weight values in weight fields of each of the media files. And then, the media file obtaining module 241 obtains a predetermined amount of media files on the top of the ordered list from the player data storage unit 12, and stores the obtained media files in a temporary file of the server data storage unit 22.

The play-list management unit 24 further includes a category table generation module 242, a final weight value generation module 243, a play-list generation module 244, and a data transmittal module 245. The category table generation module 242 reads the desired sub-categories (e.g., artists, genres) and weight values of the obtained media files in the temporary file, and thereupon aggregates a corresponding sub-category weight value in the corresponding initialized category tables by the weight values of the obtained media files, and then records the aggregated sub-category weight values in the corresponding initialized category tables. That is, the aggregated sub-category weight values associated with the artists are recorded in the first category table, whereas, the aggregated sub-category weight values associated with the genres are recorded in the second category table.

The final weight value generation module 243 calculates a final weight value of each media file stored in the server data storage unit 22 according to the updated category tables, and stores the final weight values of each media file in a temporary file in the server data storage unit 22.

The play-list generation module 244 generates a play-list according to the final weight values of the media files in the temporary file, and stores the play-list in the server data storage unit 22. The listener can further edit the play-list if desired, that is, the listener can add or delete media files listed on the play-list. The data transmittal module 245 automatically transmits the generated play-list to the media player 10 through the server interface unit 21 and the player interface 11 by the data lines 30.

The file management unit 14 further includes a data download module 142, receiving the transmitted play-list and storing the received play-list into the player data storage unit 12, thereupon the media player 10 can play the media files listed on the received play-list.

Furthermore, the play-list management unit 24 further includes a playing module 246. The playing module 246 directly plays the media files listed on the play-list generated by the play-list generation module 244, by performing the media playing software.

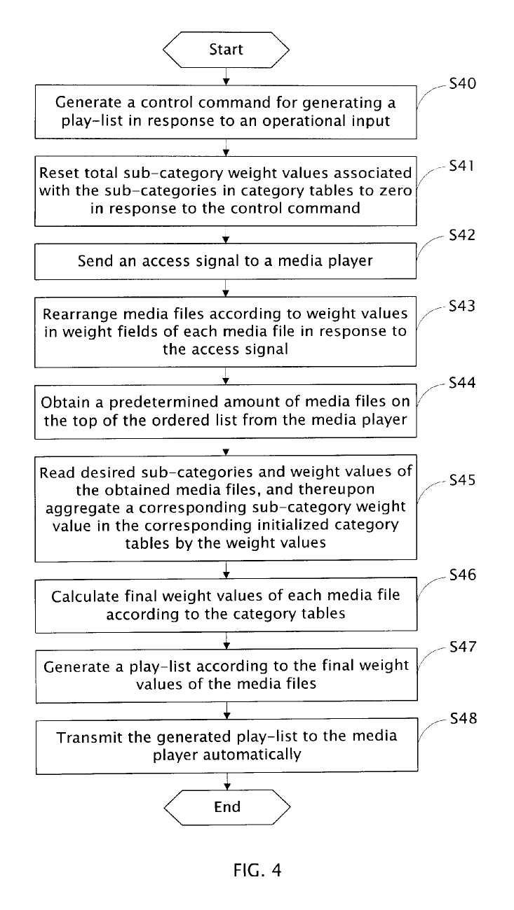

FIG. 4 is a flowchart of a preferred method for generating a play-list in the media file server 20 in FIG. 1. In a power-on state of the media player 10 and the media file server 20, a user connects the media player 10 to the media file server 20. In step S40, the command input unit 25 generates a command for generating a play-list in response to an operational input of the user, and sends the command to the server processor 23, the server processor 23 identifies the inputted command and generates a control command for generating a play-list (namely a play-list generation control command).

In step S41, the play-list management unit 24 resets sub-category weight values associated with the sub-categories in the category tables to zero (namely initializing the category tables) in response to the control command. And then, in step S42, the play-list management 24 sends an access signal to the media player 10 through the player interface unit 11 and the server interface unit 21 by the data lines 30.

In step 43, the file management unit 14 arranges the media files stored in the player data storage unit 12 based on the weight values in weight fields of each of the media files in descending order in response to the access signal. In step S44, the play-list management unit 24 of the media file server 20 obtains a predetermined amount of media files on the top of the ordered list from the media player 10, and stores the obtained media files in a temporary file of the server data storage unit 22. Then in step S45, the play-list management unit 24 reads the desired sub-categories (e.g., artists, genres) and weight values of the obtained media files in the temporary file, and thereupon aggregates a corresponding sub-category weight value in the corresponding initialized category tables by the weight values of the obtained media files.

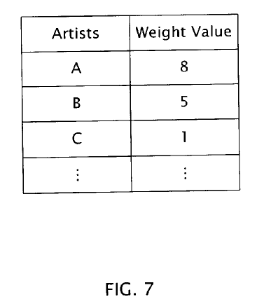

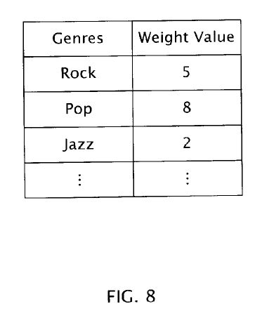

In step S46, referring to FIG. 7 and FIG. 8, the play-list management unit 24 calculates a final weight value of each media file storing in the server data storage unit 22 according to the updated category tables, and stores the final weight values of each media file in a temporary file in the server data storage unit 22.

In step S47, the play-list management unit 24 generates a play-list according to the final weight values of the media files, and stores the play-list in the server data storage unit 22. For example, the play-list management unit 24 rearranges all the media files stored in the server data storage unit 22 according to the final weight values, thereby generating a play-list therefrom. That is, the file management unit 22 orderly rearranges the media files according to the final weight values, or calls a random function that employs the final weight values of the media files as a parameter, to randomly rearrange the media files. Therefore, the media files having the greater final weight values would be listed on more front of the play-list.

Furthermore, the play-list management unit 24 may also directly select a plurality of media files each of which has a final weight value being greater than a predetermined value, thereby generating another play-list therefrom. The play-list management unit 24 may also rearrange all the media files based on the final weight values in descending order, and then selects a predetermined amount of media files on the top of the ordered list, thereby generating another play-list therefrom.

In step S48, the play-list management unit 24 transmits the play-list to the media player 10 automatically through the server interface unit 21 and the player interface 11 by the data lines 30, whereby the file management unit 14 stores the transmitted play-list into the player data storage unit 12, thereupon the media player 10 can play the media files listed on the transmitted play-list. Furthermore, the play-list management unit 24 can also directly play the media files listed on the play-list by performing the media playing software storing the player data storage unit 12.

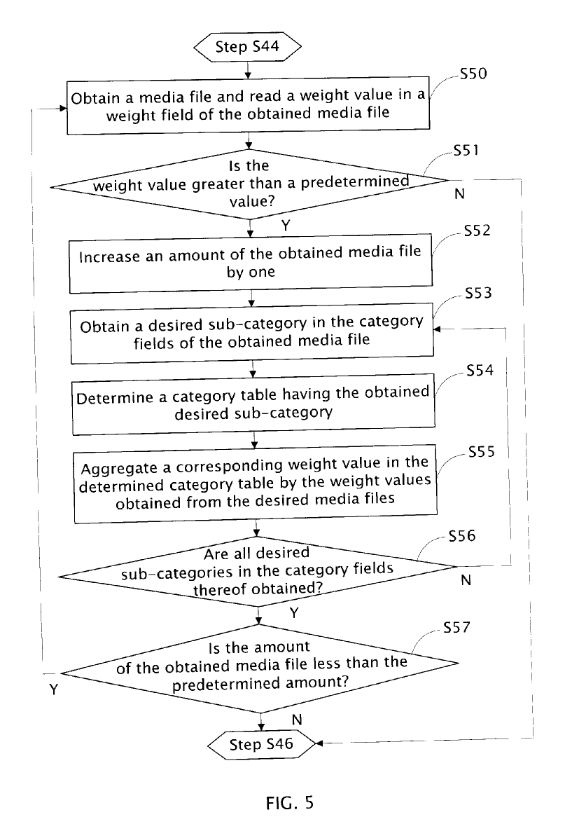

FIG. 5 is a flowchart of a preferred method for calculating sub-category weight values of desired sub-categories in FIG. 4. In step S50, the play-list management unit 24 obtains a media file from the temporary file of the server data storage unit 22, and reads a weight value in a weight field of the obtained media file. In step S51, the play-list management unit 24 determines whether the obtained weight value is greater than a predetermined value. If the obtained weight value is not greater than the predetermined value, the procedure goes to step S46. If the obtained weight value is greater than the predetermined value, in step S52, the play-list management unit 24 increases an amount of the obtained media file by one.

In step S53, the play-list management unit 24 obtains a desired sub-category (eg., an artist or a genre) in the category fields of the obtained media file. In step S54, the play-list management unit 24 determines a category table having the obtained desired sub-category. In step S55, the play-list management unit 24 aggregates a corresponding sub-category weight value in the determined category table by the weight values of the obtained media files.

In step S56, the play-list management unit 24 determines whether all desired sub-categories in the category fields of the media file are obtained. If any desired sub-category in the category fields of the media file is not obtained, the procedure goes to step S53 to obtain a next desired sub-category in the category fields of the media file. If all desired sub-categories in the category fields of the media file are obtained, in step S57, the play-list management unit 24 determines whether the amount of the obtained media file is less than the predetermined amount. If the amount of the obtained media file is less than the predetermined amount, the procedure goes to step S50. If the amount of the obtained media file is not less than the predetermined amount, the procedure goes to step S46.

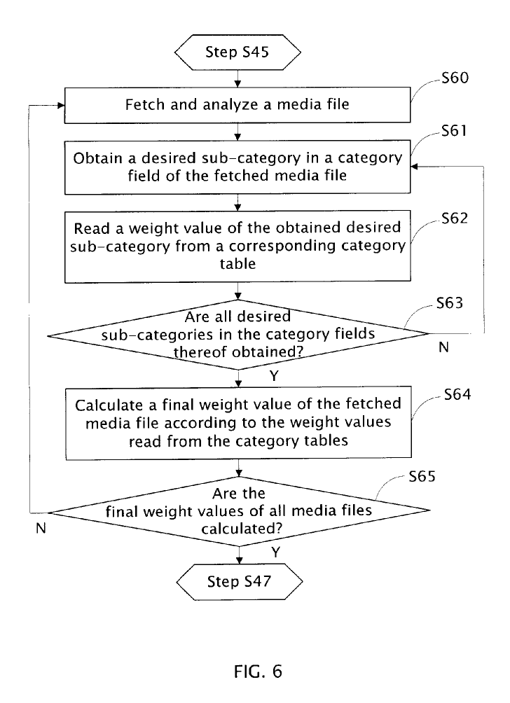

FIG. 6 is a flowchart of a preferred method for calculating final weight values of each media file in FIG. 4. In step S60, the play-list management unit 24 fetches and analyzes a media file from the server data storage unit 22. In step S61, the play-list management unit 24 obtains a desired sub-category in a category field of the fetched media file. In step S62, the play-list management unit 24 reads a sub-category weight value of the obtained desired sub-category from a corresponding category table.

In step S63, the play-list management unit 24 determines whether all desired sub-categories in the category fields of the fetched media file are obtained. If any desired sub-category in the category fields of the fetched media file is not obtained, the procedure goes to step S61. If all desired sub-categories in the category fields of the fetched media file are obtained, in step S64, the play-list management unit 24 calculates a final weight value of the fetched media file according to the obtained sub-category weight values read from the category tables and an algorithm, and stores the final weight value in a temporary file of the server data storage unit 22.

For example, the play-list management unit 24 assigns a weight value to each sub-category weight value in the updated category tables, obtains the sub-category weight values corresponding to the desired sub-categories each media file has from the updated category tables, multiplies each sub-category weight value by the corresponding weight value assigned therewith, and sums the multiplied sub-category weight values to obtain the final weight value of the media file. Alternatively, the play-list management unit 24 directly aggregates the sub-category weight values of the desired sub-categories of a media file to obtain the final weight thereof.

In step S65, the play-list management unit 24 determines whether the final weight values of all media file are calculated. If the final weight value of any media file is not calculated, the procedure goes to step S60. If the final weight values of all the media files are calculated, the procedure goes to step S47.

FIG. 7 is a schematic diagram representing a relationship between an artist and a sub-category weight value in the first category table. For simplicity, in such case, the corresponding sub-category weight value of the artist A is 8; the corresponding sub-category weight value of the artist B is 5; the corresponding sub-category weight value of the artist C is 1. However, the relationship between the artist and sub-category weight value may vary. That is, the relationship between the artist and sub-category weight value can be set and adjusted.

FIG. 8 is a schematic diagram representing a relationship between a genre and a sub-category weight value in the second category table. For simplicity, in such case, the corresponding sub-category weight value of Rock is 5; the corresponding sub-category weight value of Pop is 8; the corresponding sub-category weight value of Jazz is 2. However, the relationship between the genre and sub-category weight value may vary. That is, the relationship between the genre and sub-category weight value can be set and adjusted.

It should be emphasized that the above-described embodiments, including preferred embodiments, are merely possible examples of implementations, and are set forth for a clear understanding of the principles of the invention. Many variations and modifications may be made to the above-described embodiments without departing substantially from the spirit and principles of the invention. All such modifications and variations are intended to be included herein within the scope of this disclosure and the present invention, and be protected by the following claims.

What is claimed is:

1. A method for generating a play-list of media files in a media file server, each of the media files comprising a tag for holding a plurality of fields, the method comprising the steps of:
setting a weight field and a plurality of category fields in the tag, the weight field storing a weight value of the media file, and each category field storing a plurality of desired sub-categories corresponding to the media file;
setting a plurality of category tables in the media file server, each category table storing a desired sub-category and corresponding sub-category weight values;
resetting sub-category weight values associated with the desired sub-category in the category tables to zero in response to a control command for generating a play-list;
sending an access signal to a media player;
receiving the access signal from the media file server;
rearranging the media files stored in the media player based on the weight values in the weight fields of each media file in descending order in response to the access signal;
obtaining a predetermined amount of media files on the top of the ordered list from the media player;
reading desired sub-categories and weight values in the category fields of the obtained media files;
incrementing a corresponding sub-category weight value in the corresponding initialized category tables by the weight values of the obtained media files;
calculating final weight values of each media file according to the category tables; and
generating the play-list of the media files according to the final weight values thereof.

2. The method for generating a play-list according to claim 1, further comprising a step of: transmitting the play-list to the media player automatically.

3. The method for generating a play-list according to claim 1, wherein the step of calculating a final weight value of the media file further comprises:
obtaining the desired sub-categories in the category fields of the media file; and
obtaining the sub-category weight values of the desired sub-categories from the corresponding category tables.

4. The method for generating a play-list according to claim 3, wherein the step of calculating a final weight value of the media file further comprises:
aggregating the obtained sub-category weight values of the desired sub-categories to obtain the final weight value thereof.

5. The method for generating a play-list according to claim 3, wherein the step of calculating a final weight value of the media file further comprises:
assigns a weight value to each sub-category weight value in the updated category tables, obtains the sub-category weight values corresponding to the desired sub-categories each media file has from the updated category tables, multiplies each sub-category weight value by the corresponding weight value assigned therewith, and sums the multiplied sub-category weight values to obtain the final weight value of the media file.

6. The method for generating a play-list according to claim 1, wherein the step of generating the play-list of the media files further comprises:
rearranging all the media files according to the final weight values thereof, thereby generating the play-list therefrom.

7. The method for generating a play-list according to claim 1, wherein the step of generating the play-list of the media files further comprises:
selecting one or more media files each of which has a final weight value being greater than a predetermined value, thereby generating the play-list therefrom.

8. The method for generating a play-list according to claim 1, wherein the step of generating the play-list of the media files further comprises:
rearranging all the media files based on the final weight values in descending order, selecting a predetermined amount of media files on the top of the ordered list, thereby generating another play-list therefrom.

9. A system for generating a play-list of media files, comprising a media player and a media file server each of them storing a plurality of media files, each of the media files comprising a tag for holding a plurality of fields, wherein:
the tag of each media file comprises a weight field and a plurality of category fields, the weight field storing a weight value thereof, and each category field storing a plurality of desired sub-categories corresponding to the media file;
the media file server comprises:
a data storage unit storing a plurality of category tables, each category table storing a desired sub-category and corresponding sub-category weight values; and
a play-list management unit for resetting sub-category weight values associated with the desired sub-category in the category tables to zero in response to a control command for generating a play-list, and sending an access signal to the media player;
the media player comprises a file management unit for rearranging the media files stored in the media player based on the weight values in the weight fields of each media file in descending order in response to the access signal;
wherein the play-list management unit obtains a predetermined amount of media files on the top of the ordered list from the media player; reads desired sub-categories and weight values in the category fields of the obtained media files; increments a corresponding sub-category weight value in the corresponding initialized category tables by the weight values of the obtained media files;
calculates final weight values of each media file according to the category tables; and generates the play-list of the media files according to the final weight values thereof.

10. The system for generating a play-list according to claim 9, wherein the play-list management unit further transmits the play-list to the media player automatically.

11. The system for generating a play-list according to claim 9, wherein the play-list management unit further obtains the desired sub-categories in the category fields of the media file; and obtains the sub-category weight values of the desired sub-categories from the corresponding category tables.

12. The system for generating a play-list according to claim 11, wherein the play-list management unit further aggregates the obtained sub-category weight values of the desired sub-categories to obtain the final weight value thereof.

13. The system for generating a play-list according to claim 11, wherein the file management unit further assigns a weight value to each sub-category weight value in the updated category tables, obtains the sub-category weight values corresponding to the desired sub-categories each media file has from the updated category tables, multiplies each sub-category weight value by the corresponding weight value assigned therewith, and sums the multiplied sub-category weight values to obtain the final weight value of the media file.

14. The system for generating a play-list according to claim 9, wherein the file management unit further rearranges all the media files according to the final weight values thereof, thereby generating the play-list therefrom.

15. The system for generating a play-list according to claim 9, wherein the file management unit further selects one or more media files each of which has a final weight value being greater than a predetermined value, thereby generating the play-list therefrom.

16. The system for generating a play-list according to claim 9, wherein the file management unit further rearranges all the media files based on the final weight values in descending order, selects a predetermined amount of media files on the top of the ordered list, thereby generates another play-list therefrom.
